(19) United States
(12) Patent Application Publication
(10) Pub. No.: US 2012/0204425 A1
(43) Pub. Date: Aug. 16, 2012

(54) VALVE SEAT INSERT GAP DETECTION

(75) Inventor: Gregory J. Tomkiewicz, Milford, MI (US)

(73) Assignee: GM GLOBAL TECHNOLOGY OPERATIONS LLC, Detroit, MI (US)

(21) Appl. No.: 13/024,805

(22) Filed: Feb. 10, 2011

(51) Int. Cl. B23P 11/00; G01B 11/14

(52) U.S. Cl. 29/888.06; 356/614

(57) ABSTRACT

A method of detecting a gap extending along a longitudinal axis and defined between a shoulder of a seat formed around a port in a cylinder head and an inboard axial end of a valve seat insert disposed in the seat includes disposing a distance sensor within the port, and moving one of the distance sensor and the cylinder head relative to the other of the distance sensor and the cylinder head along the longitudinal axis to generate relative movement between the distance sensor and the cylinder head. A radial distance is sensed perpendicular to the longitudinal axis during the relative movement between the distance sensor and the cylinder head to detect a change in the radial distance at an interface between the inboard axial end of the valve seat insert and the shoulder of the seat, thereby indicating an undesirable gap therebetween.

### TECHNICAL FIELD

The invention generally relates to a method of detecting a gap extending along a longitudinal axis and defined between a shoulder of a seat formed around a port in a cylinder head and an inboard axial end of a valve seat insert disposed in the seat.

### BACKGROUND

Internal combustion engines typically include a cylinder head that is cast from aluminum or steel. The cylinder head defines a plurality of ports, e.g., intake ports and exhaust ports. Valves are disposed with in the ports, and must seal against an outer surface of the port. In order to provide a smooth and consistent surface for the valves to seal against, valve seat inserts are pressed into a seat formed into the cylinder head around each of the ports.

Each of the ports defines an interior port diameter, with each of the seats defining an interior seat diameter that is larger than the interior port diameter. Each of the seats extends along a longitudinal axis of their respective port. The seats extend from an outer surface of the cylinder head a depth into the port, and define a shoulder where the interior seat diameter transitions to the interior port diameter. The valve seat insert includes an interior insert diameter that is substantially equal to the interior port diameter. Accordingly, once properly positioned within the seat, the valve seat insert and the port define a smooth and continuous diameter. However, if the valve seat insert is not properly positioned within the seat, e.g., when the valve seat insert is not fully pressed into the seat, then a gap exists at the interface between the shoulder of the seat and an inboard axial end of the valve seat insert, which may negatively effect performance of the engine.

### SUMMARY

A method of manufacturing a cylinder head assembly for an engine is provided. The method includes forming a cylinder head. The cylinder is formed to define a port having a seat. The seat includes a shoulder that is disposed annularly about the port. A valve seat insert is pressed into the seat along a longitudinal axis. A radial distance is sensed perpendicular to the longitudinal axis along the longitudinal axis spanning across an interface between an inboard axial end of the valve seat insert and the shoulder of the seat to detect a change in the radial distance relative to the longitudinal axis at the interface.

A method of detecting a gap extending along a longitudinal axis and defined between a shoulder of a seat formed around a port in a cylinder head and an inboard axial end of a valve seat insert disposed in the seat is also provided. The method includes disposing a distance sensor within the port, and moving one of the distance sensor or the cylinder head relative to the other of the distance sensor and the cylinder head along the longitudinal axis to generate relative movement between the distance sensor and the cylinder head. A radial distance is sensed perpendicular to the longitudinal axis during the relative movement between the distance sensor and the cylinder head to detect a change in the radial distance relative to the longitudinal axis at an interface between the inboard axial end of the valve seat insert and the shoulder of the seat.

Accordingly, if the valve seat insert is not properly positioned within the seat, the distance sensor will detect a gap, or a change in distance, at the interface between the inboard axial end of the valve seat insert and the shoulder. Once a gap is identified, the valve seat insert may be properly positioned prior to the engine being assembled, thereby improving production quality.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a cylinder head assembly showing a gap at an interface between a shoulder of a seat and an inboard axial end of a valve seat insert.

FIG. 2 is a schematic cross sectional view of a distance sensor in a pre-sensing position relative to the cylinder head assembly.

FIG. 3 is a schematic cross sectional view of the distance sensor sensing a radial distance within a port of the cylinder head assembly.

FIG. 4 is an enlarged schematic cross sectional view showing the distance sensor detecting a gap at the interface between the shoulder of the seat and the inboard axial end of the valve seat insert.

FIG. 5 is a schematic plan view showing a relative relationship between a first radial distance and a second radial distance.

### DETAILED DESCRIPTION

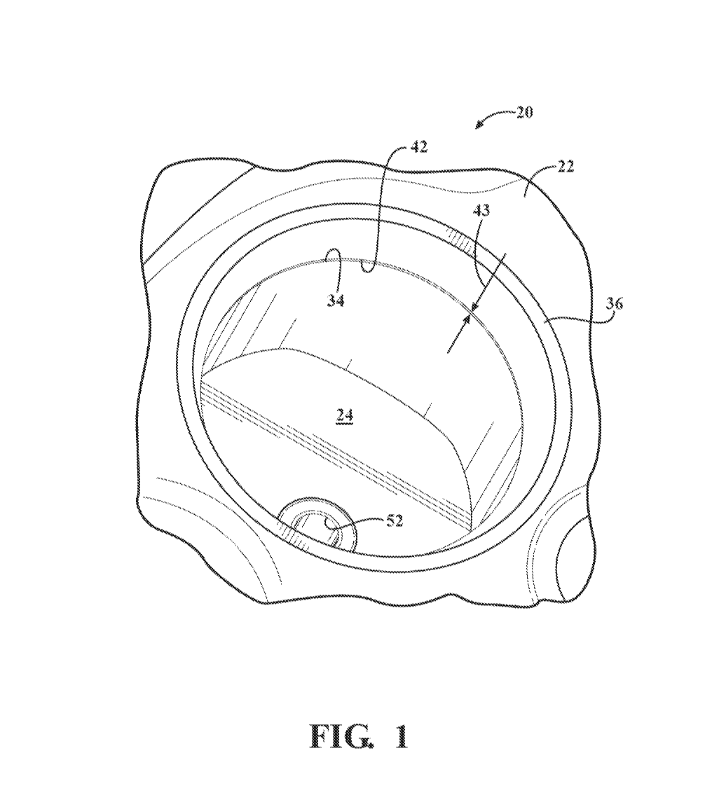

Referring to the Figures, wherein like numerals indicate like parts throughout the several views, a method of manufacturing a cylinder head assembly 20 for an engine is described. Referring to FIGS. 1 through 4, the method of manufacturing the cylinder head assembly 20 includes forming a cylinder head 22. The cylinder head 22 is formed to define at least one port 24, including but not limited to an intake port or an exhaust port. While cylinder heads 22 are typically formed to define a plurality of intake ports and a plurality of exhaust ports, the scope of the description is limited to only requiring a single port 24. However, it should be appreciated that the described method is applicable to all ports 24 defined by the cylinder head 22.

Forming the cylinder head 22 may include casting the cylinder head 22 from aluminum or steel. The cylinder head 22 may be cast with any suitable casting process, including but not limited to high pressure casting, low pressure casting, squeeze casting or sand casting. Additionally, forming the cylinder head 22 may further include machining bores, surfaces and/or other features into the cast cylinder head 22 through known machining processes.

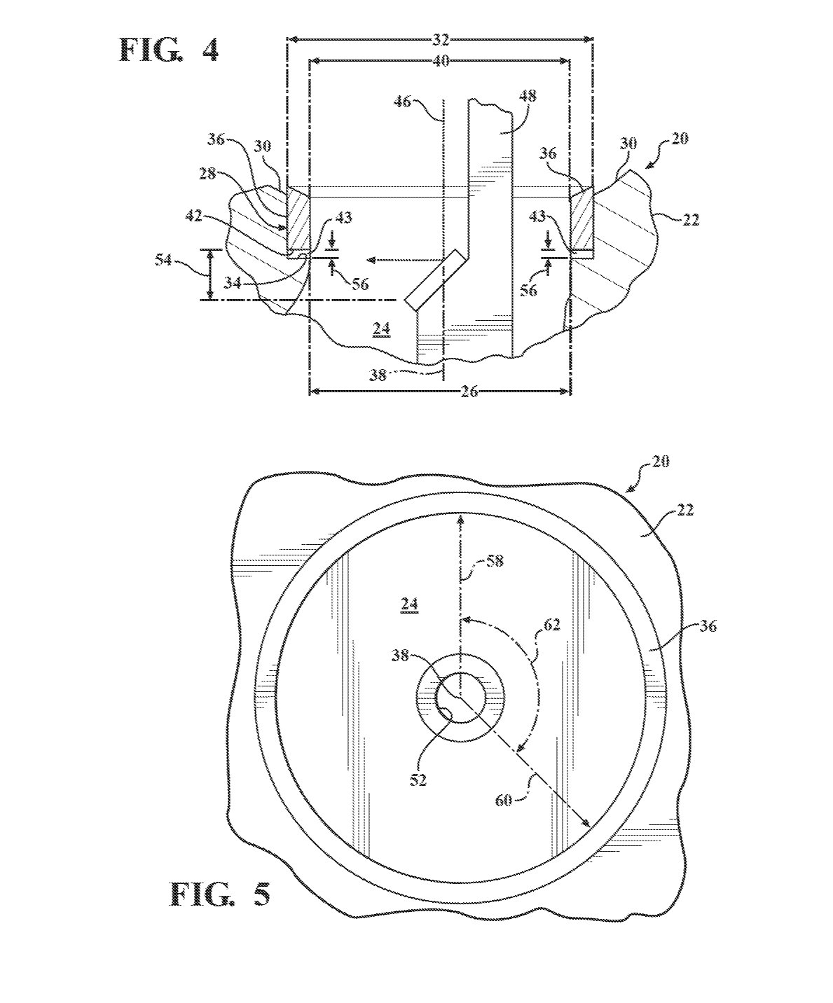

As noted above, the cylinder head 22 is formed to define the port 24. The port 24 defines an interior port diameter 26, shown in FIG. 4, and extends into the cylinder head 22. The cylinder head 22 is further formed to define a seat 28. The seat 28 is disposed adjacent an outer surface 30 of the cylinder head 22, around an outer perimeter of the port 24. The seat 28 includes an interior seat diameter 32, shown in FIG. 4, that is greater than the interior port diameter 26. The seat 28 extends a distance into the cylinder head 22 to a shoulder 34, i.e., a bottom wall, where the interior seat diameter 32 transitions to the interior port diameter 26. As such, the seat 28 and the port 24 cooperate to define a passage having a stepped diameter, with the larger diameter of the interior seat diameter 32 disposed nearer the outer surface 30 of the cylinder head 22 than the interior port diameter 26.

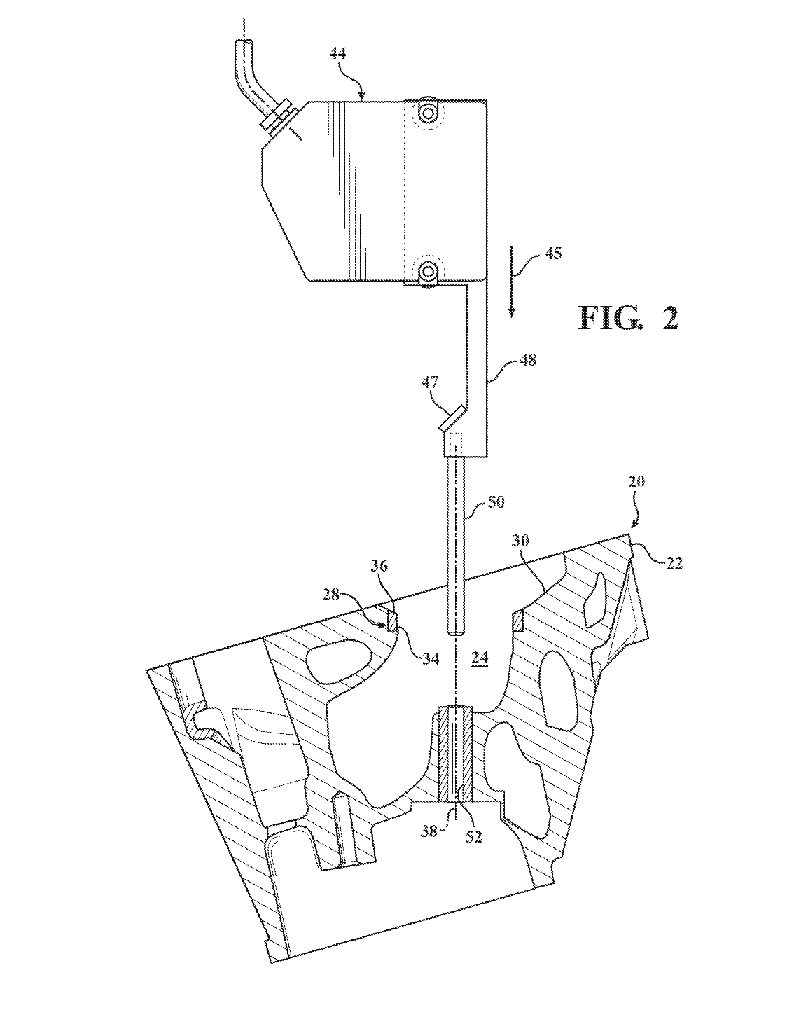

The method of manufacturing the cylinder head assembly 20 further includes pressing a valve seat insert 36 into the seat 28 along a longitudinal axis 38 of the port 24. As noted above, the cylinder head assembly 20 may include multiple ports 24, with each of the ports 24 having a valve seat insert 36 pressed therein. The valve seat insert 36 may be pressed into the seat 28 in any suitable manner, including but not limited to pressing the valve seat insert 36 with a hydraulic press or the like. The valve seat insert 36 provides a smooth, flat and consistent sealing surface for a valve (not shown) to seal against during operation of the engine. The valve seat insert 36 includes an interior insert diameter 40, shown in FIG. 4, that is substantially equal to the interior port diameter 26. As such, the difference between the interior port diameter 26 and the interior insert diameter 40 is equal to or less than 0.55 mm. As shown in FIG. 2, the valve seat insert 36 should be fully pressed into the seat 28 until an inboard axial end 42 of the valve seat insert 36 is disposed against and abuts the shoulder 34 of the seat 28, thereby providing a uniform and consistent interior diameter across an interface between the valve seat insert 36 and the shoulder 34 and/or port 24. However, on occasion the valve seat insert 36 is not fully pressed into the seat 28, thereby creating a gap 43 between the inboard axial end 42 of the valve seat insert 36 and the shoulder 34 of the seat 28, as shown in FIGS. 1, 3 and 4. Therefore, the method of manufacturing the cylinder head assembly 20 includes a method of detecting a gap 43 that extends along the longitudinal axis 38 and is defined between the shoulder 34 of the seat 28 and the inboard axial end 42 of the valve seat insert 36.

The method of detecting the gap 43 includes disposing a distance sensor 44 within the port 24. The distance sensor 44 may include but is not limited to a Charge Coupled Device (CCD) laser displacement sensor. The CCD laser displacement sensor 44 emits a continuous laser 46 that is reflected back to the CCD laser displacement sensor 44. The feedback from the laser 46 is used to calculate the distance from the sensor to the reflecting object as is known. The CCD laser projecting sensor 44 projects the laser 46 axially along and coaxial with the longitudinal axis 38. The laser 46 is deflected by a mirror 47 or other similar device at a ninety degree (90°) angle relative to the longitudinal axis 38, thereby reflecting the laser 46 onto the interior surface of the valve seat insert 36, the seat 28 and/or the port 24 to sense the radial distance between the longitudinal axis 38 and the valve seat insert 36, the seat 28 and/or the port 24 respectively.

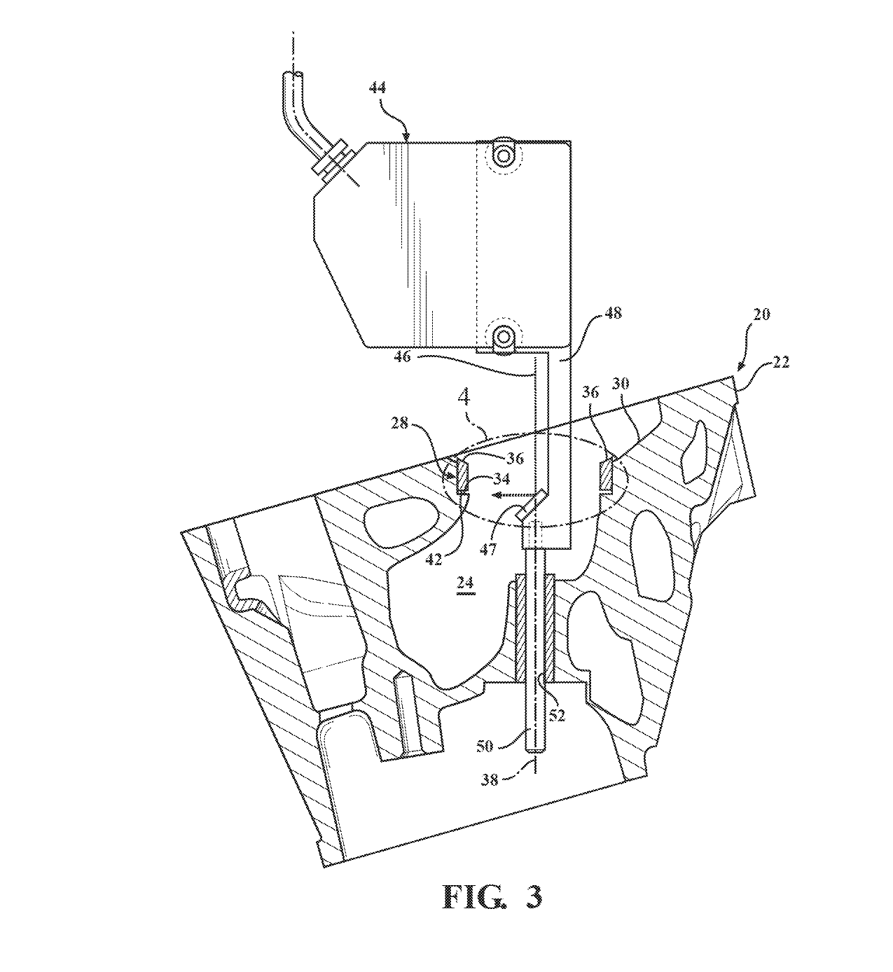

Referring to FIG. 2, the distance sensor 44 is shown disposed outside of the cylinder head assembly 20 in a pre-sensing position. Referring to FIG. 3, the distance sensor 44 is shown disposed within the port 24 of the cylinder head assembly 20. As shown in FIGS. 2 and 3, the distance sensor 44 may be disposed in the port 24 by mounting the distance sensor 44 to a bracket 48 having an extended probe 50, and positioning the probe 50 of the bracket 48 within a valve guide 52 defined by the cylinder head 22. Positioning the probe 50 in the valve guide 52 positions the distance sensor 44 appropriate position relative to the cylinder head 22 to align the laser 46 of the CCD laser displacement sensor 44 along and coaxial with the longitudinal axis 38. It should be appreciated that the distance sensor 44 may be positioned relative to the cylinder head 22 in some other manner not shown or described herein.

The method of detecting the gap 43 further includes moving one of the distance sensor 44 and the cylinder head 22 relative to the other of the distance sensor 44 and the cylinder head 22 along the longitudinal axis 38, generally indicated by arrow 45 shown in FIG. 2, which generates relative movement between the distance sensor 44 and the cylinder head 22. It should be appreciated that the cylinder head 22 may be moved relative to the distance sensor 44, or that the distance sensor 44 may be moved relative to the cylinder head 22.

Referring to FIG. 4, the method of detecting the gap 43 further includes sensing a radial distance perpendicular to the longitudinal axis 38 along a length 54 of the longitudinal axis 38 that spans across the interface between the inboard axial end 42 of the valve seat insert 36 and the shoulder 34 of the seat 28. Sensing the radial distance along the length 54 which spans across the interface allows the distance sensor 44 to detect a change in the radial distance at the interface if the gap 43 exists. If a gap 43 exists at the interface between the inboard axial end 42 of the valve seat insert 36 and the shoulder 34 of the seat 28, such as shown in FIGS. 1, 3 and 4, the sensed radial distance will change. More specifically, as the distance sensor 44 begins sensing the radial distance along the length 54, a value is returned measuring the radius of the interior insert diameter 40. As the distance sensor 44 continues to sense the radial distance during the relative movement between the distance sensor 44 and the cylinder head 22, the laser 46 will sense the radius of the interior seat diameter 32 once the distance sensor 44 moves inboard past the inboard axial end 42 of the valve seat insert 36. This change in sensed radial distances indicates and/or identifies the presence of a gap 43 between the inboard axial end 42 of the valve seat insert 36 and the shoulder 34 of the seat 28. If no gap 43 exists at the interface between the inboard axial end 42 of the valve seat insert 36 and the shoulder 34 of the seat 28, i.e., the valve seat insert 36 is completely and fully positioned within the seat 28, such as shown in FIG. 2, then the sensed radial distance will not change during the relative movement between the distance sensor 44 and the cylinder head 22. This is because the interior insert diameter 40 is substantially equal to the interior port diameter 26. More specifically, as the distance sensor 44 begins sensing the radial distance along the length 54, a value is returned measuring the radius of the interior insert diameter 40. As the distance sensor 44 continues to sense the radial distance during the relative movement between the distance sensor 44 and the cylinder head 22, the laser 46 will sense the radius of the interior port diameter 26 once the distance sensor 44 moves inboard past the inboard axial end 42 of the valve seat insert 36. These two values are substantially identical, i.e., within acceptable manufacturing tolerances, thereby indicating the lack of a gap 43 between the inboard axial end 42 of the valve seat insert 36 and the shoulder 34 of the seat 28, i.e., no gap 43.

As noted above, acceptable tolerances between the interior port diameter 26 and the interior insert diameter 40 include values equal to or less than 0.55 mm. Accordingly, the distance sensor 44 may be configured to detect and/or identify a gap 43 when a change in the radial distance at the interface is greater than 1.00 mm, as a change in the radial distance that is less than 1.00 mm falls within acceptable manufacturing tolerances, and would indicate that no gap 43 exists.

As may be inferred from above, sensing the radial distance perpendicular to the longitudinal axis 38 may include sensing the radial distance perpendicular to the longitudinal axis 38 during the relative movement between the distance sensor 44 and the cylinder head 22. Furthermore, the radial distance may be continuously sensed, or may be intermittingly sensed at appropriate intervals to detect the gap 43 should one exist.

The method of detecting the gap 43 may further include measuring a gap length 56 of a detected gap 43 along the longitudinal axis 38 to determine if the gap length 56 is greater than 0.050 mm. A gap length 56 of less than 0.050 mm is within acceptable manufacturing tolerances, whereas a gap length 56 greater than 0.050 mm is greater than acceptable manufacturing tolerances and must be corrected. As such, a motion sensor or the like may sense the relative movement between the distance sensor 44 and the cylinder head 22, and record the distance over which a gap 43 is detected.

In order to identify occurrences where the valve seat insert 36 is misaligned rather than not fully pressed into the seat 28, the radial distance may be measured at two or more radial locations about the longitudinal axis 38. If the valve seat insert 36 is misaligned, at least a portion of the valve seat insert 36 may be disposed adjacent the shoulder 34 such that no gap 43 exists at the interface, and another portion of the valve seat insert 36 may be spaced from the shoulder 34 at the interface such that a gap 43 does exist. Accordingly, measuring the radial distance in multiple angular locations ensures that the radial distance is not randomly measured where no gap 43 exists, while a gap 43 does exists at another location due to the valve seat insert 36 being misaligned.

As such, referring to FIG. 5, sensing the radial distance perpendicular to the longitudinal axis 38 may include sensing a first radial distance 58 and a second radial distance 60, with the second radial distance 60 angularly spaced from the first radial distance 58. As shown in FIG. 5, the first radial distance 58 and the second radial distance 60 are angularly spaced from each other an angle 62. The angle 62 is preferably at least one hundred twenty degrees (120°), however, the angle 62 may be less than the 120° shown.

While the best modes for carrying out the invention have been described in detail, those familiar with the art to which this invention relates will recognize various alternative designs and embodiments for practicing the invention within the scope of the appended claims.

1. A method of manufacturing a cylinder head assembly for an engine, the method comprising:
forming a cylinder head defining a port having a seat having a shoulder disposed annularly about the port;
pressing a valve seat insert into the seat along a longitudinal axis; and
sensing a radial distance perpendicular to the longitudinal axis along the longitudinal axis spanning across an interface between an inboard axial end of the valve seat insert and the shoulder of the seat to detect a change in the radial distance relative to the longitudinal axis at the interface.

2. A method as set forth in claim 1 further comprising disposing a distance sensor within the port.

3. A method as set forth in claim 2 wherein the distance sensor includes a Charge Coupled Device (CCD) laser displacement sensor.

4. A method as set forth in claim 2 further comprising moving one of the distance sensor and the cylinder head relative to the other of the distance sensor and the cylinder head along the longitudinal axis to generate relative movement between the distance sensor and the cylinder head.

5. A method as set forth in claim 4 wherein moving one of the distance sensor and the cylinder head relative to the other of the distance sensor and the cylinder head includes moving the cylinder head relative to the distance sensor.

6. A method as set forth in claim 4 wherein moving one of the distance sensor and the cylinder head relative to the other of the distance sensor and the cylinder head includes moving the distance sensor relative to the cylinder head.

7. A method as set forth in claim 4 wherein sensing the radial distance perpendicular to the longitudinal axis is further defined as sensing the radial distance perpendicular to the longitudinal axis during the relative movement between the distance sensor and the cylinder head.

8. A method as set forth in claim 7 wherein sensing the radial distance during the relative movement between the distance sensor and the cylinder head is further defined as continuously sensing the radial distance during the relative movement between the distance sensor and the cylinder head.

9. A method as set forth in claim 1 wherein sensing the radial distance perpendicular to the longitudinal axis includes sensing a first radial distance and a second radial distance angularly spaced from the first radial distance.

10. A method as set forth in claim 9 wherein the first radial distance and the second radial distance are angularly spaced from each other an angle of at least one hundred twenty degrees (120°).

11. A method as set forth in claim 2 wherein sensing the radial distance perpendicular to the longitudinal axis include projecting a laser from the distance sensor axially along the longitudinal axis and deflecting the laser at a ninety degree (90°) angle relative to the longitudinal axis onto an interior surface of the valve seat insert, the seat and/or the port to sense the radial distance.

12. A method as set forth in claim 1 wherein sensing a radial distance perpendicular to the longitudinal axis along a length of the longitudinal axis spanning across an interface between an inboard axial end of the valve seat insert and the shoulder of the seat to detect a change in the radial distance at the interface is further defined as sensing a radial distance perpendicular to the longitudinal axis along a length of the longitudinal axis spanning across an interface between an inboard axial end of the valve seat insert and the shoulder of the seat to detect a change in the radial distance at the interface that is greater than 1.00 mm.

13. A method as set forth in claim 1 further comprising measuring a length of a detected gap along the longitudinal axis to determine if the gap is greater than 0.050 mm.

14. A method of detecting a gap extending along a longitudinal axis and defined between a shoulder of a seat formed around a port in a cylinder head and an inboard axial end of a valve seat insert disposed in the seat, the method comprising:
disposing a distance sensor within the port;
moving one of the distance sensor and the cylinder head relative to the other of the distance sensor and the cylinder head along the longitudinal axis to generate relative movement between the distance sensor and the cylinder head; and
sensing a radial distance perpendicular to the longitudinal axis during the relative movement between the distance sensor and the cylinder head to detect a change in the radial distance relative to the longitudinal axis at an interface between the inboard axial end of the valve seat insert and the shoulder of the seat.

15. A method as set forth in claim 14 wherein the distance sensor includes a Charge Coupled Device (CCD) laser displacement sensor.

16. A method as set forth in claim 14 wherein sensing the radial distance during the relative movement between the distance sensor and the cylinder head is further defined as continuously sensing the radial distance during the relative movement between the distance sensor and the cylinder head.

17. A method as set forth in claim 14 wherein sensing the radial distance perpendicular to the longitudinal axis includes sensing a first radial distance and a second radial distance angularly spaced from the first radial distance.

18. A method as set forth in claim 17 wherein the first radial distance and the second radial distance are angularly spaced from each other an angle of at least one hundred twenty degrees (120°).

19. A method as set forth in claim 14 wherein sensing the radial distance perpendicular to the longitudinal axis includes projecting a laser from the distance sensor axially along the longitudinal axis and deflecting the laser at a ninety degree (90°) angle relative to the longitudinal axis onto an interior surface of the valve seat insert, the seat and/or the port to sense the radial distance.

20. A method of detecting a gap extending along a longitudinal axis and defined between a shoulder of a seat formed around a port in a cylinder head and an inboard axial end of a valve seat insert disposed in the seat, the method comprising:
disposing a Charge Coupled Device (CCD) laser displacement sensor within the port,
moving one of the CCD laser displacement sensor and the cylinder head relative to the other of the CCD laser displacement sensor and the cylinder head along the longitudinal axis to generate relative movement between the CCD laser displacement sensor and the cylinder head;
projecting a laser from the CCD laser displacement sensor axially along the longitudinal axis and deflecting the laser at a ninety degree (90°) angle relative to the longitudinal axis onto an interior surface of the valve seat insert, the seat and/or the port to sense the radial distance; and
continuously sensing a radial distance perpendicular to the longitudinal axis during the relative movement between the CCD laser displacement sensor and the cylinder head to detect a change in the radial distance relative to the longitudinal axis at an interface between the inboard axial end of the valve seat insert and the shoulder of the seat.
